(19) United States
(12) Patent Application Publication
(10) Pub. No.: US 2023/0126823 A1
(43) Pub. Date: Apr. 27, 2023

(54) SYSTEM AND METHOD FOR ADAPTING TO CHANGING RESOURCE LIMITATIONS

(71) Applicant: InterDigital CE Patent Holdings, Paris (FR)

(72) Inventors: Francois Schnitzler, Saint Avé (FR); Anne Lambert, Saint-Aubin-d'Aubigné (FR); Francoise Le Bolzer, Rennes (FR)

(73) Assignee: InterDigital CE Patent Holdings, Paris (FR)

(21) Appl. No.: 17/911,866

(22) PCT Filed: Mar. 12, 2021
(86) PCT No.: PCT/EP2021/056303

§ 371 Date: Sep. 15, 2022

(30) Foreign Application Priority Data
Mar. 17, 2020 (EP) 20305274.1

(51) Int. Cl. G06N 3/044

(52) U.S. Cl. CPC G06N 3/044

(57) ABSTRACT

In general, at least one example of an embodiment can involve determining a constraint associated with processing a sequence of data, adapting a neural network based on the constraint, wherein adapting the neural network comprises modifying, based on the constraint, a characteristic of a decision function included in the neural network; and enabling processing of at least a first portion of the sequence of data utilizing the adapted neural network and in accordance with the constraint.

### TECHNICAL FIELD

The present disclosure involves artificial intelligence systems and methods.

### BACKGROUND

Systems such as a home network may contain dedicated resources to manage services in the home in connection with/at the request of heterogeneous consumer electronics (CE) devices in the home. For example, such services can include artificial intelligence (AI) resources, systems and methods used to control CE devices, e.g., by learning and adapting to any of a plurality of variables such as the environment in which devices are located, user(s) of the device, etc. An aspect of such services can be a system or device referred to herein as an “AI hub”, a boosted AI CPE (“consumer premises equipment” such as STB, gateway, edge computing resources, etc.). This can be a central node within the system to provide, for example, a) virtualization environment to host AI micro services and b) ensure interoperability with connected CE devices or Edge computing, access to services and resources (compute, storage, video processing, AI/ML (machine learning) accelerator). In addition, an AI hub can offload computational AI tasks to other CE devices registered in the Home Data Center.

### SUMMARY

In general, at least one example of an embodiment described herein involves an AI system and method that can adapt its configuration or architecture based on an instruction.

In general, at least one other example of an embodiment involves a neural network system and method that can communicate with and/or be driven by a control device to adapt a configuration of the neural network based on a constraint.

In general, at least one example of an embodiment involves apparatus comprising: one or more processors configured to determine a constraint associated with processing a sequence of data; adapt a neural network based on the constraint, wherein the one or more processors being configured to adapt the neural network comprises the one or more processors being configured to modify, based on the constraint, a characteristic of a decision function included in the neural network; and enable processing of at least a first portion of the sequence of data utilizing the adapted neural network and in accordance with the constraint.

In general, at least one example of an embodiment involves a method comprising: determining a constraint associated with processing a sequence of data; adapting a neural network based on the constraint, wherein adapting the neural network comprises modifying, based on the constraint, a characteristic of a decision function included in the neural network; and enabling processing at least a first portion of the sequence of data utilizing the adapted neural network in accordance with the constraint.

In general, at least one example of an embodiment involves apparatus comprising: one or more processors configured to implement a neural network including a decision function; adapt the neural network based on a constraint, wherein the one or more processors being configured to adapt the neural network comprises the one or more processors being configured to modify a characteristic of the decision function based on the constraint; and process data utilizing the adapted neural network in accordance with the constraint.

In general, at least one example of an embodiment involves a method comprising: implementing a neural network including a decision function; adapting the neural network based on a constraint, wherein adapting the neural network comprises modifying a characteristic of the decision function associated with the neural network based on the constraint; and processing data utilizing the adapted neural network in accordance with the constraint.

In general, at least one example of an embodiment involves apparatus comprising: one or more processors configured to implement a neural network including a decision function; adapt the neural network based on a constraint, wherein the one or more processors being configured to adapt the neural network comprises the one or more processors being configured to modify one or more parameters of the decision function based on the constraint; and process data utilizing the adapted neural network in accordance with the constraint.

In general, at least one example of an embodiment involves a method comprising: implementing a neural network including a decision function; adapting the neural network based on a constraint, wherein adapting the neural network comprises modifying one or more parameters of the decision function associated with the neural network based on the constraint; and processing data utilizing the adapted neural network in accordance with the constraint.

In general, at least one example of an embodiment involves apparatus comprising: one or more processors configured to adapt a neural network including a decision function based on a constraint, wherein the one or more processors being configured to adapt the neural network comprises the one or more processors being configured to modify one or more parameters of the decision function based on the constraint; and process data utilizing the adapted neural network in accordance with the constraint.

In general, at least one example of an embodiment involves a method comprising: adapting a neural network based on a constraint, wherein adapting the neural network comprises modifying, based on the constraint, one or more parameters of a decision function associated with the neural network; and processing data utilizing the adapted neural network in accordance with the constraint.

In general, at least one other example of an embodiment involves a neural network (RNN) system and method that can communicate with and/or be driven by a control device to adapt a configuration of the neural network based on a constraint, where the constraint comprises at least one of a resource availability or an accuracy requirement.

In general, at least one other example of an embodiment provides a recurrent neural network (RNN) system and method that can communicate with and/or be driven by a control device to adapt a configuration of the RNN based on a resource availability.

In general, at least one other example of an embodiment provides a recurrent neural network (RNN) system and method that can communicate with and/or be driven by an orchestrator/scheduler to modify a computational cost of the RNN based on modifying a characteristic of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining whether to update the at least one cell of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining how many hidden states of the RNN to update.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, and modifying the characteristic comprises modifying at least one parameter of the decision function.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, modifying the characteristic comprises modifying at least one parameter of the decision function, and the at least one parameter comprises a binarization function associated with one or more perceptrons of the RNN.

In general, at least one other example of an embodiment provides a recurrent neural network (RNN) system and method that can communicate with and/or be driven by an orchestrator/scheduler to modify a computational cost of the RNN based on adjusting a value of at least one parameter of the RNN, wherein the at least one parameter comprises f_{binarize} associated with one or more perceptrons of the RNN.

In general, at least one other example of an embodiment provides a method for controlling a computational cost of RNN by an orchestrator/scheduler.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF DESCRIPTION OF THE DRAWING

The present disclosure may be better understood by considering the detailed description below in conjunction with the accompanying figures, in which:

FIG. 1 provides a graph illustrating data processing in accordance with one or more aspects of the examples of systems and methods described herein;

FIG. 2 provides two graphs illustrating data processing in accordance with one or more aspects of the examples of systems and methods described herein;

FIG. 3 illustrates an example of a data input useful for explaining one or more aspects of the present disclosure;

FIG. 4 illustrates an example of an embodiment of a system in accordance with the present disclosure;

FIG. 5 illustrates another example of an embodiment of a system in accordance with the present disclosure;

FIG. 6 provides a graph illustrating data processing in accordance with one or more aspects of the examples of systems and methods described herein;

FIG. 7 illustrates an example of an embodiment of a method in accordance with the present disclosure; and

FIG. 8 illustrates an example of an embodiment of a system suitable for implementing one or more aspects of the present disclosure.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

One aspect of AI hub functionality involves allocating computational resources to various AI services. At some point, the demand may exceed the available resources and a control system, or processor, or software, generally referred to herein as an “orchestrator”, will operate to limit resources available to some or all services. An orchestrator/scheduler can provide for controlling where and when learning models are executed. For example, an orchestrator/scheduler may provide at least one or more of the following functionalities:
allocate computational resources to deep models
decide on which hardware the model is run
monitor resource availability
monitor the execution of a process (including a ML model)
selects the model to be run.

An aspect of the present disclosure involves providing systems and methods that avoid severe disruption or shutdown by enabling adaptation to constraints such as resource requirements and/or resource availability (e.g., computational resource availability or requirements) and/or accuracy requirements. In general, at least one example of an embodiment described herein involves a flexible AI system that can receive an instruction or instructions from an orchestrator or a scheduler running the AI hub and adapt its configuration or architecture or model in accordance with the instruction. For example, an instruction might be based on, or provide an indication of, constraints such as current resource requirements or availability or accuracy and instruct the neural network to change one or more characteristics or parameters to adapt to the current constraints. If the constraint or constraints change then one or more additional instructions can be provided to further adapt the neural network to the changed constraint.

The use of an orchestrator and flexible AI systems to maintain a reasonable quality of service may also be implemented on a single device running multiple AI processes. For example, a device such as a smartphone can contain dedicated hardware to accelerate AI processes and enabling such devices to run or provide the functionality of an orchestrator. Other possible devices include smart cars, computers, home assistants or other devices capable of communication via a network such as a home network, e.g., Internet of things, or IoT devices.

In addition, edge computing may involve AI processes and associated resource constraints, e.g., where cloud services are run on edge computing nodes close to the user. As an example, when processes are moved to a new edge node, constraints such as resource availability, e.g., computational resource availability, might be different.

A deep neural network (DNN) is a complex function. A DNN is composed of several neural layers (typically in series) and each neural layer is composed of several perceptrons. A perceptron is a function involving a linear combination of the inputs and a non-linear function, for example a sigmoid function. Trained by a machine learning algorithm on huge data sets, these models have recently proven extremely useful for a wide range of applications and have led to significant improvements to the state-of-the-art in artificial intelligence, computer vision, audio processing and several other domains.

Recurrent neural networks (RNN) denote a class of deep learning architectures specifically designed to process sequences such as sound, videos, text or sensor data. RNN are widely used for such data. Frequently used RNN architectures include long short-term memory (LSTM) networks and gated recurrent units (GRU). Typically, RNN maintain a “state”, a vector of variables, over time. This state is supposed to accumulate relevant information and is updated recursively. At a high-level, this is like hidden Markov models. Each input of the sequence is typically a) processed by some deep layers and b) then combined with the previous state through some other deep layers to compute the new state. Hence, the RNN can be seen as a function taking a sequence of inputs x=(x₁, . . . , x_{T}) and recursively computing a set of states s=(s₁, . . . , s_{T}). Each state sₜ is computed from sₜ₋₁ and xₜ by a cell S of the RNN.

Fully processing the input can be resource intensive. In a constrained environment, this may be undesirable. An approach to reduce the computational load of RNNs involves a “skip-RNN” architecture. This architecture is designed to allow the model to skip some inputs by introducing a state update gate. This part of the model is trained along with the other parameters of the model to maximize accuracy while limiting computational cost. The resulting architecture can be described as follows:

uₜ=f_{binarize}(ũₜ)

sₜ=uₜS(sₜ₋₁,xₜ)+(1−uₜ)sₜ₋₁

Δúₜ=σ(Wsₜ+b)

ũₜ₊₁=uₜΔũₜ+(1−uₜ)(ũₜ+min(Δũₜ,1−ũₜ)).

In these equations, f_{binarize} denotes a binarization function (in other words, the output is 0 if the input is smaller than 0.5 and 1 otherwise), σ a non-linear function and W and b the trainable parameters of the linear part of the state update gate (a perceptron). f_{binarize} can also be a stochastic sampling from a Bernoulli distribution whose parameter is the input ũₜ.

This model is trained on a dataset containing a set of input sequences and label(s) associated to each sequence. The model is trained to minimize a loss computed on this labeled data. The loss is the sum of two terms: one term related to the accuracy of the task (for example cross-entropy for classification or Euclidian loss for regression), and a second term that penalizes computational operations: L_{budget}=λΣₜuₜ, where λ is a weight controlling the strength of the penalty and uₜ, as defined above, is 0 if there is no update to the state and 1 if there is.

There are other approaches similar to skipRNN that propose an alternative mechanism to reduce computation dynamically based on inputs, for example by also skipping some or only updating part of the state vector. These mechanisms include a decision function, similar to the equations described above. Examples of other approaches include Jump-LSTM, Skim-RNN, VCRNN, and G-LSTM.

Skip-RNN and other related approaches aim to reduce computation while maintaining accuracy. While they allow the system to run using fewer computational resources, the system is fixed and cannot adapt to changing computational constraints. Furthermore, these approaches do not provide for communication with an orchestrator/scheduler.

In general, at least one example of an embodiment described herein involves an artificial intelligence system or method, e.g., a system or method based on a Recurrent Neural Network (RNN) architecture, that can be controlled, e.g., by an orchestrator, to adapt its computation to available computational resources. In fact, there is no RNN architecture that can adapt to changing computational resources. Therefore, RNNs running on shared hardware might be shut down if other processes require the use of the resources. This includes both multiple networks running on the same hardware (for example, a smartphone or a car) or on different devices (such as a home system with heterogeneous devices).

In general, at least one example of an embodiment described herein involves an AI system and method that can adapt its configuration or architecture based on an instruction.

In general, at least one other example of an embodiment provides a recurrent neural network (RNN) system and method that can communicate with and/or be driven by a control device to adapt a configuration of the RNN based on a resource availability.

In general, at least one other example of an embodiment provides a recurrent neural network (RNN) system and method that can communicate with and/or be driven by an orchestrator/scheduler to modify a computational cost of the RNN based on modifying a characteristic of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining whether to update the at least one cell of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining how many hidden states of the RNN to update

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, and modifying the characteristic comprises modifying at least one parameter of the decision function.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, modifying the characteristic comprises modifying at least one parameter of the decision function, and the at least one parameter comprises a binarization function associated with one or more perceptrons of the RNN.

In general, at least one other example of an embodiment provides a method for controlling a computational cost of RNN by an orchestrator/scheduler.

The following first describes the architecture that allows the model to adapt its computational cost and then describes how to allow an orchestrator/scheduler to leverage this capacity.

In general, at least one example of an embodiment involves varying a computational cost of an AI system or method based on an architecture such as RNN. In an embodiment, an architecture of the model can be similar to the skipRNN model. However, the decision function is different in that the decision function can be modified based on constraints such as computational resources, computational cost, and/or accuracy requirements. The modification of the decision function can occur based on an indication of such constraints where, for example, the indication is provided by a control feature such as an orchestrator or scheduler. As an example of modification of the decision function, the decision function may include one or more characteristics or parameters that can be modified. In accordance with one aspect of the present disclosure, one such characteristic or parameter, f_{binarize} is different than described above. For example, the function accepts an additional parameter, thr, that may be viewed as a threshold value:

$${u}_{t} = {f}_{binarize} ( {\tilde{u}}_{t} , thr ) = \{ \begin{matrix}0 if {\tilde{u}}_{t} < thr \\ 1 otherwise\end{matrix} .$$

Varying thr changes the behavior of the model. When it increases, the model will skip more inputs. At the same time, the model still adapts its computation to the data. Modifying thr gracefully trades off accuracy for computational cost as explained in more detail below.

This architecture can be trained like the skipRNN model. Implementing the gates as described above allows the model to be trained on minibatches of data using one or more processors such as graphics processing units (GPUs) and stochastic gradient descent. The model can be trained with a fixed thr and used as it. It could also be trained by varying that parameter during training, either to fixed but different values for each minibatch or to different values for different points in the sequence.

At inference, thr can be modified dynamically. An example of an approach to implement this is to modify the input of the model. In addition to the inputs x=(x₁, . . . , x_{T}), the model can receive a sequence of parameters thr=(thr₁, . . . , thr_{T}). The parameters can be generated by the orchestrator/scheduler, or the system itself. How these parameters can be chosen to achieve a desired result is described below in detail with regard to both a first example involving parameter generation by an orchestrator/scheduler and a second example involving generation by the system itself. For example, a sequence of parameters could be (0.5, 0.5, 0.5, . . . , 0.5, 0.6, 0.6, . . . 0.6). When the value changes from 0.5 to 0.6, the model will use fewer computational resources. These parameters can then be fed to the f_{binarize}.

As an alternative, the parameter can be static, that is, stored in the model, and changed when necessary. For the static use case, the parameter could be changed through different methods, e.g.:
in memory; or
by using a specific API with the model; or
by loading another version of the model that contains the new parameter value.

As in skipRNN, inference would typically be performed with a different implementation than for training. Regarding inference/training differences, both architectures can be used for any task. However, using the multiplicative implementation (described in the skip-RNN equations) is likely to be much faster for training. Using the conditional implementation (e.g., tf.cond function of the tensorflow deep learning framework) is better for inference. Using the multiplicative implementation for inference will not save any computation and thus will be pointless. When using a deep learning framework such as tensorflow or Pytorch, and depending on the framework used, the training implementation will typically not achieve any computational gain as both the skip and the non-skip operation are computed at every time step. For inference, the condition ũₜ<thr must be evaluated before computing unnecessary values and, if true, the input must be skipped and related computations must be performed. This can for example be achieved using eager execution or by using conditional operators such as tf.cond.

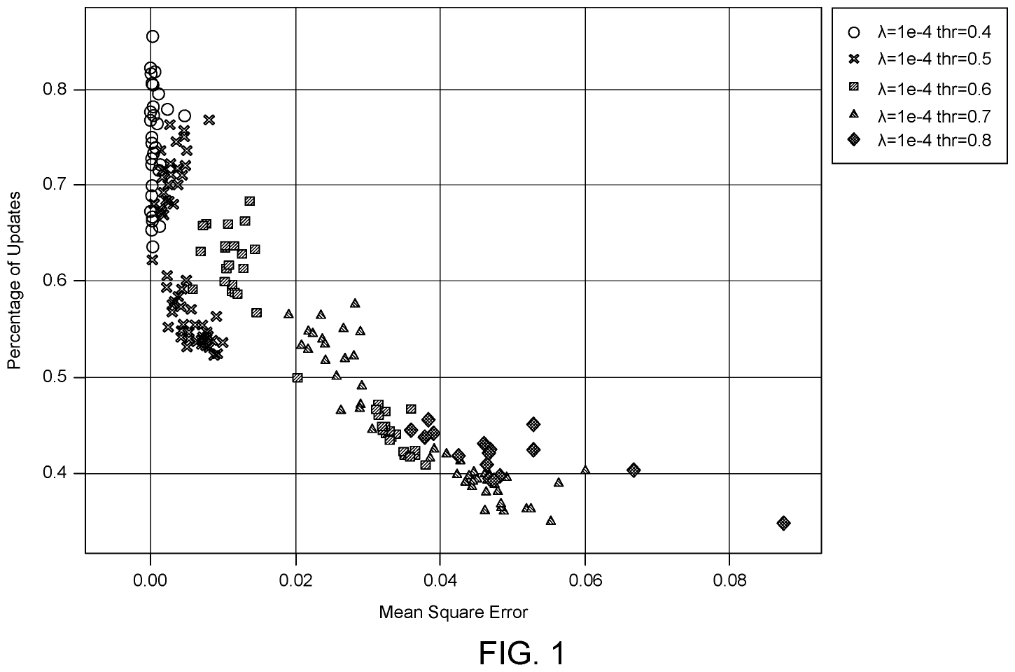

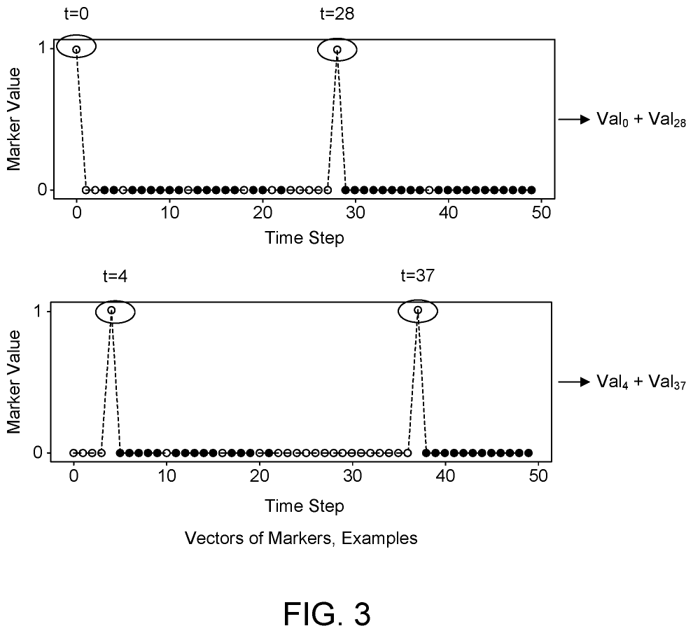

An example of an embodiment is now described with respect to FIGS. 1 through 4. The example involves processing data associated with a benchmark problem called “adding task”. In this problem, the RNN takes as input a sequence of pairs (value; marker), where each value is a random number drawn uniformly between −0.5 and 0.5 and marker is either 0 or 1. The task of the network is to output the sum of the markers associated to a value “1”. For the example described here, input data sequences of length 50 were used that contained two positive markers. The position of the first marker is drawn from a uniform distribution over the first 10% markers and the position of the second marker is from a uniform distribution over the second half of the sequence. Two examples of the described data sequence are illustrated in FIG. 3.

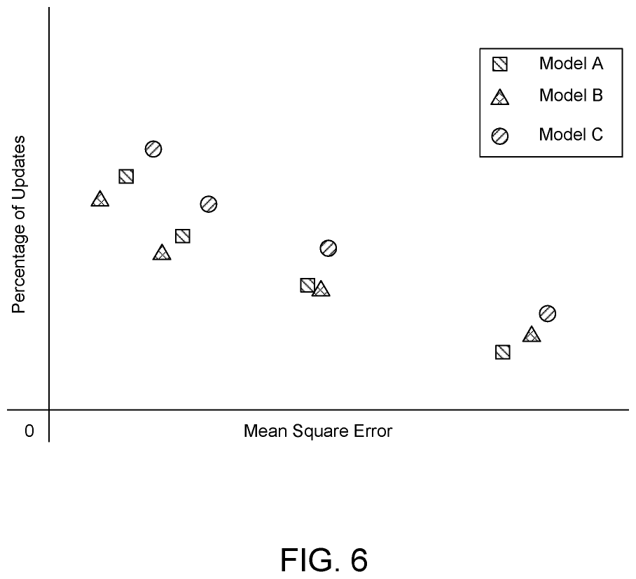

Results, presented in FIG. 1, show that modifying thr smoothly (see below) trades off accuracy for computational efficiency. The figure shows the result achieved by different models trained with λ=10⁻⁴ and thr=0.5. Typically, only one model would be selected and used based on criteria associated with a particular application, dataset or other aspect of a particular problem or situation being addressed by the system. For example, such criteria might be accuracy (e.g., measured by the mean square error to the correct output) and computational costs (e.g., measured as the number of skipped states). A model that provides desirable or “best” results, e.g., a particular tradeoff of accuracy vs. computational cost, for a particular situation could be selected. However, a “best” model might not be unique. As shown in FIG. 1, each model defines a Pareto frontier between accuracy and efficiency (e.g., see https://en.wikipedia.org/wiki/Pareto_efficiency). Different points are obtained by varying thr. Some models might be worse than others along most or all of the frontier. Some models might be better for one part of the frontier only. In that case, selection is a matter of choice based, for example, on whether accuracy or efficiency is favored for a particular situation. Another example of a Pareto frontier is shown in FIG. 6.

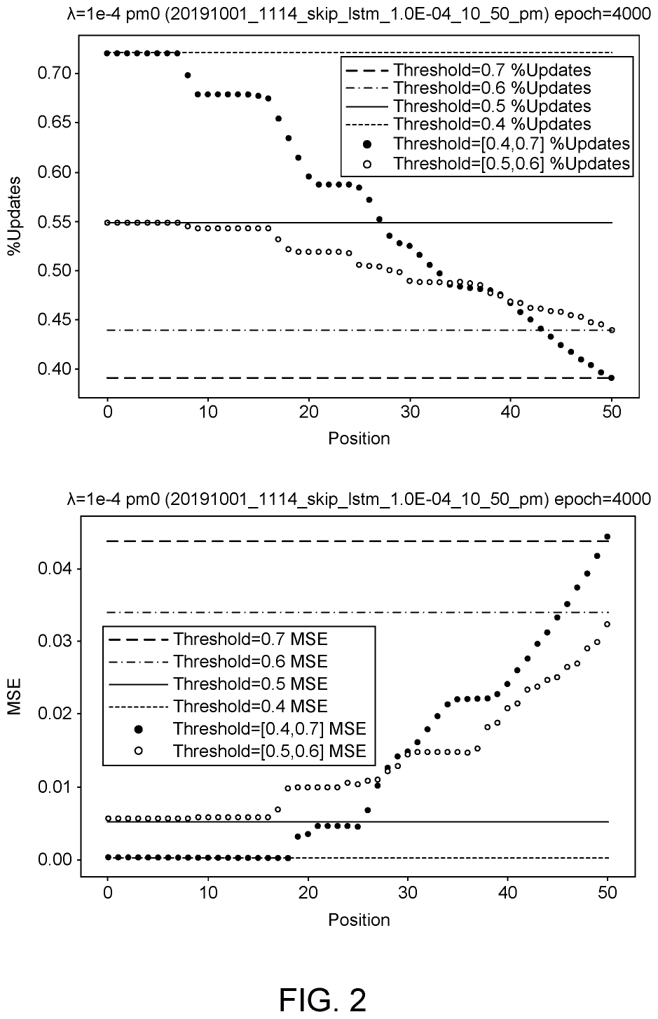

Modifying thr “smoothly” as mentioned above means the following.
Models obtained by varying thr improves on accuracy and degrades on computational efficiency (or the opposite).
These variations tend to increase with the magnitude of the change in thr.
The models obtained do not have trivial accuracy (except possibly for large changes in thr) where “trivial accuracy” means the accuracy of a model making random guesses. For example, with 10 classes that are equally likely in the dataset, trivial accuracy would be 10%.
   At least one example of an embodiment enables adapting a model, e.g., modifying the computational complexity of a RNN, during the analysis of a sequence. Therefore, one or more embodiments as described herein can be applied on models analyzing a stream of data, such as sensor readings or cameras. This is illustrated in FIG. 2 which shows modifying thr during the analysis of one sequence of the “adding task” where the modifications of thr occur at different positions of the sequence (x axis in the graphs in FIG. 2). The results for two different pairs of thr values and averaged over 10000 sequences, are shown in FIG. 2. The percentage of updates is shown in the upper graph in FIG. 2; accuracy is shown in the lower graph. The graphs in FIG. 2 illustrate that the performance of the model gradually transitions between two accuracy and computational costs, depending on when thr was modified. The number of updates decreases (upper figure) and the error increases (lower figure) as thr is increased. The earlier the modification of thr, the larger the impact. That is, the resulting accuracy, resp. computational cost is a weighted average of the corresponding metrics of the models used. The weight of each model increases with the number of time steps a model is used

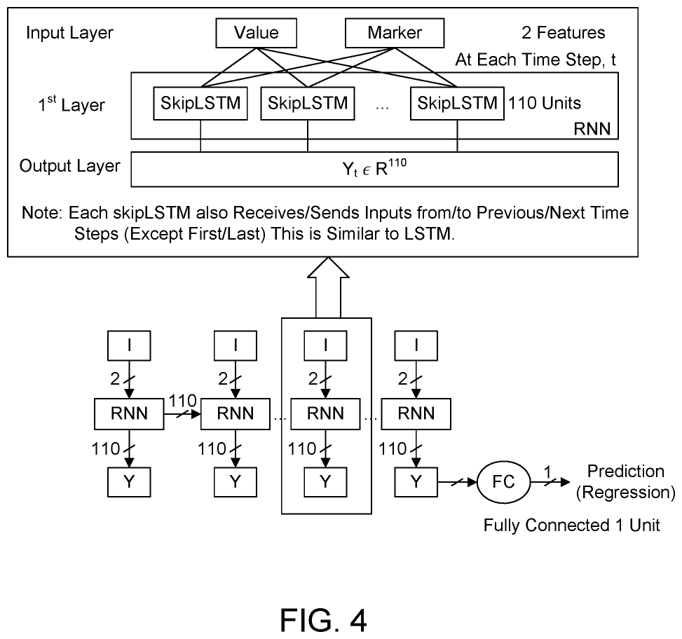

FIG. 4 illustrates an example of an embodiment of a system suitable for processing a sequence such as that shown in FIG. 3 and producing results such as those shown in FIGS. 1 and 2. In FIG. 4, the lower portion illustrates an overview of the unrolled RNN loop across time. The upper portion of FIG. 4 illustrates the RNN architecture for one time step.

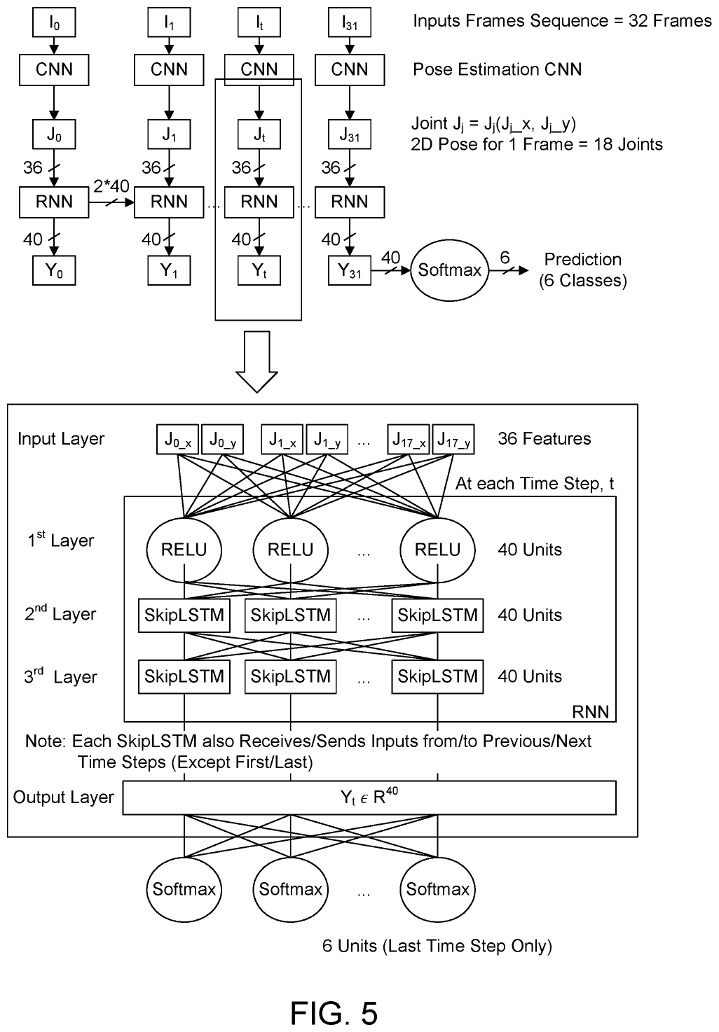

FIG. 5 illustrates another example of an embodiment in accordance with the present disclosure and involving a different task than that shown in FIGS. 1-4 and described above. That is, FIG. 5 provides an example of an embodiment providing an architecture for a pose classification task. In FIG. 5, the upper portion shows an overview of the multilevel system architecture. The lower portion of FIG. 5 illustrates the architecture of one level.

The architecture described above has a computational cost that can be tuned by varying thr. Examples of embodiments for controlling thr include, but are not limited to, the following.
1) The model can have in its metadata and/or expose through other means to the orchestrator/scheduler information about the expected behavior of the model. This information could for example be a table containing pairs of (thr, expected computational cost). The computational cost can for example be expressed in FLOPS and denote the expected cost per element of the input vector or for sequences of different lengths. The table may also contain the expected accuracy associated to each thr value. The orchestrator can then use this information to drive the behavior of the model by selecting thr and sending it to the model.
2) The information could be encoded differently, for example by a function accepting as input any thr value and returning the expected computational cost, or a function accepting as input a computational cost and returning the thr value expected to achieve that cost. In an embodiment, the orchestrator can monitor the model to check that the actual computational cost matches the information provided and may adjust its requests or control of the model to take a potential bias into account.
3) The model may also monitor itself (e.g., through the number of skip operations) and adjust/recompute the information provided to the scheduler.
4) The information/function relating thr to the expected computational cost can be a machine learning model.
5) The same information as above, i.e., of thr vs. cost and/or accuracy, can be stored within the model, either within or outside the computational graph of the deep model. The orchestrator/scheduler can then give the model a target computational cost and/or minimum accuracy value. The model can then use the table or function to translate this target computational cost into a thr value. As in example (1) above, the model may monitor itself to adapt the information to its current working conditions and data.
6) Various command mechanisms can be used between the orchestrator/scheduler and the model. For example, an embodiment could enable the orchestrator/scheduler to order the model to increase or decrease the computational resources it uses by a set amount. The orchestrator/scheduler could also tell the model to increase/decrease said resources by a factor (e.g., 2; or 0.5; or 0.8; etc.).

For any one or more of the described examples of embodiments, the requests of the orchestrator/scheduler (for example thr values) may be provided as input to the model (for example as an additional element in the vector x=(x₁, . . . , x_{T})). The orchestrator/scheduler may also communicate with the model through other appropriate mechanisms such as:
webAPI for that purpose, including REST, SOAP etc.
models may monitor resources allocated to its container (if it runs in a container) and adapt themselves.
modification of a file looked up by the model.
communication through a socket if running on same computer.

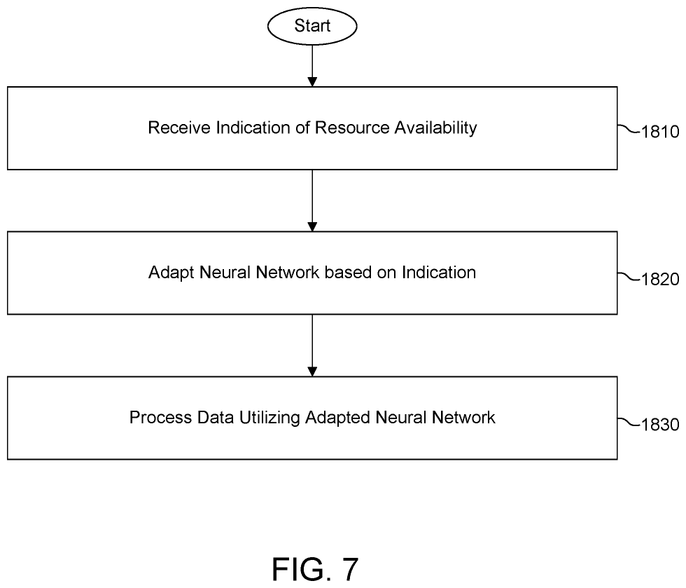

FIG. 7 illustrates another example of an embodiment comprising a method in accordance with the present disclosure. In FIG. 7, at 1810 a system, e.g., one of the examples of embodiments of a neural network as described herein such as that shown in FIG. 4 or 5 or 8, receives an indication of a resource availability such as a resource limitation or a resource requirement. For example, an orchestrator might communicate a need for additional resources. Alternatively, the indication might be a value of thr that corresponds to increasing or decreasing resource usage. Next, at 1820 a neural network is adapted based on the indication. For example, adapting the neural network may comprise modifying a parameter of a binarization function associated with the neural network based on the indication, e.g., modifying thr. Then, at 1830, the system processes data utilizing the adapted neural network in accordance with the resource availability.

This document describes various examples of embodiments, features, models, approaches, etc. Many such examples are described with specificity and, at least to show the individual characteristics, are often described in a manner that may appear limiting. However, this is for purposes of clarity in description, and does not limit the application or scope. Indeed, the various examples of embodiments, features, etc., described herein can be combined and interchanged in various ways to provide further examples of embodiments.

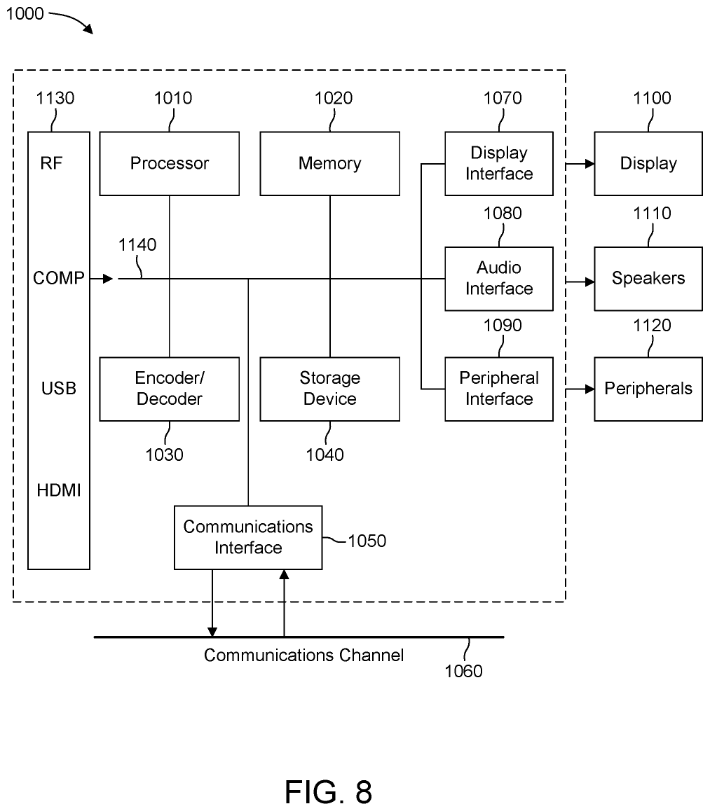

In general, the examples of embodiments described and contemplated in this document can be implemented in many different forms. For example, FIG. 8 described below provides an embodiment, but other embodiments are contemplated and the discussion of FIG. 8 does not limit the breadth of the implementations. At least one embodiment generally provides an example related to artificial intelligence systems. This and other embodiments can be implemented as a method, an apparatus, a computer readable storage medium or non-transitory computer readable storage medium having stored thereon instructions for implementing one or more of the examples of methods described herein.

Various methods are described herein, and each of the methods comprises one or more steps or actions for achieving the described method. Unless a specific order of steps or actions is required for proper operation of the method, the order and/or use of specific steps and/or actions may be modified or combined.

Various embodiments, e.g., methods, and other aspects described in this document can be used to modify a system such as the example shown in FIG. 8 that is described in detail below. For example, one or more devices, features, modules, etc. of the example of FIG. 8, and/or the arrangement of devices, features, modules, etc. of the system (e.g., architecture of the system) can be modified. Unless indicated otherwise, or technically precluded, the aspects, embodiments, etc. described in this document can be used individually or in combination.

Various numeric values are used in the present document, for example. The specific values are for example purposes and the aspects described are not limited to these specific values.

FIG. 8 illustrates a block diagram of an example of a system in which various aspects and embodiments can be implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 can include an encoder/decoder module 1030 configured, for example, to process image data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream or signal, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during operations such as those described herein. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010. Similarly, aspects of USB or HDMI interface processing can be implemented within separate interface ICs or within processor 1010. The demodulated, error corrected, and demultiplexed stream is provided to various processing elements, including, for example, processor 1010, and encoder/decoder 1030 operating in combination with the memory and storage elements to process the datastream for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various generalized as well as particularized embodiments are also supported and contemplated throughout this disclosure. Examples of embodiments in accordance with the present disclosure include but are not limited to the following.

In general, at least one example of an embodiment provides apparatus comprising: one or more processors configured to determine a constraint associated with processing a sequence of data; adapt a neural network based on the constraint, wherein the one or more processors being configured to adapt the neural network comprises the one or more processors being configured to modify, based on the constraint, a characteristic of a decision function included in the neural network; and enable processing of at least a first portion of the sequence of data utilizing the adapted neural network and in accordance with the constraint.

In general, at least one example of an embodiment provides a method comprising: determining a constraint associated with processing a sequence of data; adapting a neural network based on the constraint, wherein adapting the neural network comprises modifying, based on the constraint, a characteristic of a decision function included in the neural network; and enabling processing at least a first portion of the sequence of data utilizing the adapted neural network in accordance with the constraint.

In general, at least one example of an embodiment provides apparatus comprising: one or more processors configured to implement a neural network including a decision function; adapt the neural network based on a constraint, wherein the one or more processors being configured to adapt the neural network comprises the one or more processors being configured to modify a characteristic of the decision function based on the constraint; and process data utilizing the adapted neural network in accordance with the constraint.

In general, at least one example of an embodiment provides a method comprising: implementing a neural network including a decision function; adapting the neural network based on a constraint, wherein adapting the neural network comprises modifying a characteristic of the decision function associated with the neural network based on the constraint; and processing data utilizing the adapted neural network in accordance with the constraint.

In general, at least one example of an embodiment provides apparatus comprising: one or more processors configured to implement a neural network including a decision function; adapt the neural network based on a constraint, wherein the one or more processors being configured to adapt the neural network comprises the one or more processors being configured to modify one or more parameters of the decision function based on the constraint; and process data utilizing the adapted neural network in accordance with the constraint.

In general, at least one example of an embodiment provides a method comprising: implementing a neural network including a decision function; adapting the neural network based on a constraint, wherein adapting the neural network comprises modifying one or more parameters of the decision function associated with the neural network based on the constraint; and processing data utilizing the adapted neural network in accordance with the constraint.

In general, at least one example of an embodiment provides apparatus comprising: one or more processors configured to adapt a neural network including a decision function based on a constraint, wherein the one or more processors being configured to adapt the neural network comprises the one or more processors being configured to modify one or more parameters of the decision function based on the constraint; and process data utilizing the adapted neural network in accordance with the constraint.

In general, at least one example of an embodiment provides a method comprising: adapting a neural network based on a constraint, wherein adapting the neural network comprises modifying, based on the constraint, one or more parameters of a decision function associated with the neural network; and processing data utilizing the adapted neural network in accordance with the constraint.

In general, at least one example of an embodiment provides a recurrent neural network (RNN) system and method that can communicate with and/or be driven by an orchestrator/scheduler to modify a computational cost of the RNN based on modifying a characteristic of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining whether to update the at least one cell of the RNN.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining how many hidden states of the RNN to update.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, and modifying the characteristic comprises modifying at least one parameter of the decision function.

In general, at least one other example of an embodiment provides a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, modifying the characteristic comprises modifying at least one parameter of the decision function, and the at least one parameter comprises a binarization function associated with one or more perceptrons of the RNN.

In general, at least one other example of an embodiment provides a recurrent neural network (RNN) system and method that can communicate with and/or be driven by an orchestrator/scheduler to modify a computational cost of the RNN based on adjusting a value of at least one parameter of the RNN, wherein the at least one parameter comprises f_{binarize} associated with one or more perceptrons of the RNN. In general, at least one example of an embodiment can involve apparatus comprising one or more processors configured to implement a neural network including a decision function; receive an indication of a resource availability; adapt the neural network based on the indication, wherein the one or more processors being configured to adapt the neural network comprises the one or more processors being configured to modify the decision function based on the indication; and process data utilizing the adapted neural network in accordance with the resource availability.

In general, at least one other example of an embodiment involves a method comprising: receiving an indication of a resource availability; adapting a neural network based on the indication, wherein adapting the neural network comprises modifying a decision function associated with the neural network based on the indication; and processing data utilizing the adapted neural network in accordance with the resource availability.

In general, at least one other example of an embodiment can involve an apparatus or method including a neural network as described herein, wherein the neural network comprises a recurrent neural network.

In general, at least one other example of an embodiment can involve an apparatus or method including a recurrent neural network as described herein, wherein the recurrent neural network comprises a skip neural network.

In general, at least one other example of an embodiment can involve an apparatus or method receiving an indication, wherein the indication is received from an orchestrator.

In general, at least one other example of an embodiment can involve an apparatus or method including adapting a neural network, wherein the adapting occurs during training of the neural network.

In general, at least one other example of an embodiment can involve an apparatus or method including adapting a neural network during training, wherein adapting during training comprises varying a parameter for each of a plurality of minibatches of data during training.

In general, at least one other example of an embodiment can involve an apparatus or method including a neural network adapted based on varying a parameter, wherein the parameter comprises a variable parameter varied by an orchestrator based on resource availability.

In general, at least one other example of an embodiment can involve an apparatus or method including a neural network adapted by varying a parameter, wherein the parameter comprises a variable parameter and the variable parameter is varied based on determining a computational cost associated with adapting the neural network.

In general, at least one other example of an embodiment can involve an apparatus or method including a neural network and determining a computational cost associated with adapting the neural network, wherein determining the computational cost comprises evaluating the computational cost using a machine learning model. In general, at least one other example of an embodiment can involve an apparatus or method including a neural network adapted based on determining a computational cost associated with varying a parameter, wherein determining the computational cost comprises providing information to an orchestrator regarding a behavior of the neural network and processing the information by the orchestrator to determine the parameter.

In general, at least one other example of an embodiment can involve an apparatus or method including a neural network adapted based on providing information to an orchestrator, wherein providing the information to the orchestrator comprises providing metadata including the information to the orchestrator.

In general, at least one other example of an embodiment can involve an apparatus or method including a neural network adapted by varying a parameter of a binarization function, wherein the parameter of the binarization function comprises a threshold value at which the binarization function value switches between 0 and 1.

In general, at least one example of an embodiment can involve a computer program product including instructions, which, when executed by a computer, cause the computer to carry out any one or more of the methods described herein.

In general, at least one example of an embodiment can involve a non-transitory computer readable medium storing executable program instructions to cause a computer executing the instructions to perform any one or more of the methods described herein.

In general, at least one example of an embodiment can involve a device comprising an apparatus according to any embodiment of apparatus as described herein, and at least one of (i) an antenna configured to receive a signal, the signal including data representative of information such as instructions from an orchestrator, (ii) a band limiter configured to limit the received signal to a band of frequencies that includes the data representative of the information, and (iii) a display configured to display an image such as a displayed representation of the data representative of the instructions.

In general, at least one example of an embodiment can involve a device as described herein, wherein the device comprises one of a television, a television signal receiver, a set-top box, a gateway device, a mobile device, a cell phone, a tablet, or other electronic device.

Regarding the various embodiments described herein and the figures illustrating various embodiments, when a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, one or more of a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “obtaining” various pieces of information. Obtaining the information can include one or more of, for example, determining the information, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for refinement. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream or signal of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments have been described. Embodiments may include any of the following features or entities, alone or in any combination, across various different claim categories and types:
Providing apparatus comprising: one or more processors configured to determine a constraint associated with processing a sequence of data; adapt a neural network based on the constraint, wherein the one or more processors being configured to adapt the neural network comprises the one or more processors being configured to modify, based on the constraint, a characteristic of a decision function included in the neural network; and enable processing of at least a first portion of the sequence of data utilizing the adapted neural network and in accordance with the constraint.
Providing a method comprising: determining a constraint associated with processing a sequence of data; adapting a neural network based on the constraint, wherein adapting the neural network comprises modifying, based on the constraint, a characteristic of a decision function included in the neural network; and enabling processing at least a first portion of the sequence of data utilizing the adapted neural network in accordance with the constraint.
Providing apparatus comprising: one or more processors configured to implement a neural network including a decision function; adapt the neural network based on a constraint, wherein the one or more processors being configured to adapt the neural network comprises the one or more processors being configured to modify a characteristic of the decision function based on the constraint; and process data utilizing the adapted neural network in accordance with the constraint.
Providing a method comprising: implementing a neural network including a decision function; adapting the neural network based on a constraint, wherein adapting the neural network comprises modifying a characteristic of the decision function associated with the neural network based on the constraint; and processing data utilizing the adapted neural network in accordance with the constraint.
Providing apparatus comprising: one or more processors configured to implement a neural network including a decision function; adapt the neural network based on a constraint, wherein the one or more processors being configured to adapt the neural network comprises the one or more processors being configured to modify one or more parameters of the decision function based on the constraint; and process data utilizing the adapted neural network in accordance with the constraint.
Providing a method comprising: implementing a neural network including a decision function; adapting the neural network based on a constraint, wherein adapting the neural network comprises modifying one or more parameters of the decision function associated with the neural network based on the constraint; and processing data utilizing the adapted neural network in accordance with the constraint.
Providing apparatus comprising: one or more processors configured to adapt a neural network including a decision function based on a constraint, wherein the one or more processors being configured to adapt the neural network comprises the one or more processors being configured to modify one or more parameters of the decision function based on the constraint; and process data utilizing the adapted neural network in accordance with the constraint.
Providing a method comprising: adapting a neural network based on a constraint, wherein adapting the neural network comprises modifying, based on the constraint, one or more parameters of a decision function associated with the neural network; and processing data utilizing the adapted neural network in accordance with the constraint.
Providing a recurrent neural network (RNN) system and method that can communicate with and/or be driven by an orchestrator/scheduler to modify a computational cost of the RNN based on modifying a characteristic of the RNN.
Providing a recurrent neural network (RNN) system and method that can communicate with and/or be driven by an orchestrator/scheduler to modify a computational cost of the RNN based on modifying a characteristic of the RNN, wherein the characteristic comprises a decision function of the RNN.
Providing a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN.
Providing a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining whether to update the at least one cell of the RNN.
Providing a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN and the decision function comprises determining how many hidden states of the RNN to update.
Providing a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, and modifying the characteristic comprises modifying at least one parameter of the decision function.
Providing a recurrent neural network (RNN) system and method that can communicate with and/or be driven by an orchestrator/scheduler to modify a computational cost of the RNN based on modifying a characteristic of the RNN, wherein the characteristic comprises a decision function of at least one cell of the RNN, and the decision function comprises determining whether to update the at least one cell of the RNN, modifying the characteristic comprises modifying at least one parameter of the decision function, and the at least one parameter comprises a binarization function associated with one or more perceptrons of the RNN.
Providing a recurrent neural network (RNN) system and method that can communicate with and/or be driven by an orchestrator/scheduler to modify a computational cost of the RNN based on adjusting a value of at least one parameter of the RNN, wherein the at least one parameter comprises f_{binarize} associated with one or more perceptrons of the RNN.
Providing apparatus comprising one or more processors configured to implement a neural network including a decision function; receive an indication of a resource availability; adapt the neural network based on the indication, wherein the one or more processors being configured to adapt the neural network comprises the one or more processors being configured to modify one or more parameters of the decision function based on the indication; and process data utilizing the adapted neural network in accordance with the resource availability;
Providing a method comprising: receiving an indication of a resource availability; adapting a neural network based on the indication, wherein adapting the neural network comprises modifying one or more parameters of a decision function associated with the neural network based on the indication; and processing data utilizing the adapted neural network in accordance with the resource availability;
Providing an apparatus or method including a neural network as described herein, wherein the neural network comprises a recurrent neural network; Providing an apparatus or method including a recurrent neural network as described herein, wherein the recurrent neural network comprises a skip neural network;
Providing an apparatus or method including a neural network receiving an indication as described herein, wherein the indication is received from an orchestrator;
Providing an apparatus or method including adapting a neural network, wherein the adapting occurs during training of the neural network;
Providing an apparatus or method including adapting a neural network during training, wherein adapting during training comprises varying a parameter for each of a plurality of minibatches of data during training;
Providing an apparatus or method including a neural network adapted based on varying a parameter, wherein the parameter comprises a variable parameter varied by an orchestrator based on resource availability;
Providing an apparatus or method including a neural network adapted by varying a parameter, wherein the parameter comprises a variable parameter and the variable parameter is varied based on determining a computational cost associated with adapting the neural network;
Providing an apparatus or method including a neural network and determining a computational cost associated with adapting the neural network, wherein determining the computational cost comprises evaluating the computational cost using a machine learning model;
Providing an apparatus or method including a neural network adapted based on determining a computational cost associated with varying a parameter, wherein determining the computational cost comprises providing information to an orchestrator regarding a behavior of the neural network and processing the information by the orchestrator to determine the parameter;
Providing an apparatus or method including a neural network adapted based on providing information to an orchestrator, wherein providing the information to the orchestrator comprises providing metadata including the information to the orchestrator;
Providing an apparatus or method including a neural network adapted by varying one or more parameters of a decision function, wherein the one or more parameters comprise a binarization function and the binarization function comprises a threshold value at which the binarization function value switches between 0 and 1.
Providing a computer program product including instructions, which, when executed by a computer, cause the computer to carry out any one or more of the methods described herein.
Providing a non-transitory computer readable medium storing executable program instructions to cause a computer executing the instructions to perform any one or more of the methods described herein.
Providing a device comprising an apparatus according to any embodiment of apparatus as described herein, and at least one of (i) an antenna configured to receive a signal, the signal including data representative of information such as instructions from an orchestrator, (ii) a band limiter configured to limit the received signal to a band of frequencies that includes the data representative of the information, and (iii) a display configured to display an image such as a displayed representation of the data representative of the instructions.
Providing a device as described herein, wherein the device comprises one of a television, a television signal receiver, a set-top box, a gateway device, a mobile device, a cell phone, a tablet, a server or other electronic device.

Various other generalized, as well as particularized embodiments are also supported and contemplated throughout this disclosure.

1-29. (canceled)

30. A method performed by a wireless transmit receive unit (WTRU), the method comprising:
receiving an input data sequence;
receiving a first indication of a first constraint for processing a first portion of the input data sequence, wherein the first indication indicates a relationship between the first constraint and a neural network (NN) for processing the first portion of the input data sequence;
processing the first portion of the input data sequence at a first time utilizing the NN based on the first indication;
while continuing to receive the input data sequence, receiving a second indication of a second constraint for processing a second portion of the input data sequence, wherein the second indication indicates a relationship between the second constraint and the NN for processing the second portion of the input data sequence; and
adapting, based on the second indication, the NN to process the second portion of the input data sequence, wherein the NN is adapted to be modified according to one or more parameters of a function based on the second indication to process the second portion of the input data sequence; and
processing the second portion of the input data sequence at a second time utilizing the adapted NN based on the second indication.

31. The method of claim 30, wherein the first constraint comprises at least one of a computational resource availability or a data processing accuracy.

32. The method of claim 31, wherein the NN has a computational load, wherein the computational load is greater before being adapted than after being adapted, and wherein the first indication indicates a greater computational resource availability than the second indication.

33. The method of claim 32, wherein the adaptation of the NN causes the NN to skip more of the second portion of the input data sequence than the first portion of the input data sequence that was processed by the NN based on the first indication.

34. The method of claim 32, wherein the NN comprises a skip recurrent NN (RNN) model, wherein the skip RNN model has a lower computational load when processing the second portion of the input data sequence than when processing the first portion of the input data sequence.

35. The method of claim 32, further comprising:
transmitting, to a device other than the WTRU, at least one value indicating a computational cost value or an accuracy value associated with the NN when processing the input data sequence.

36. The method of claim 32, wherein the NN is adapted to enable processing of the second portion of the input data with a lower computational load, and wherein the NN is configured to minimize a loss in accuracy after the adaptation.

37. The method of claim 31, further comprising:
receiving, from a device other than the WTRU, a target computational cost value or an accuracy value, wherein the NN is adapted to achieve the target computational cost or the accuracy value.

38. The method of claim 32, further comprising:
receiving, from a device other than the WTRU, a command to increase or decrease the computational load of the NN by a defined amount; and
adapting, based on the command, the NN to process a third portion of the input data sequence.

39. The method of claim 30, wherein the input data sequence comprises video data or audio data, and wherein the processing is performed using an encoder or a decoder on the WTRU.

40. A wireless transmit receive unit (WTRU) comprising a processor, the processor configured to:
receive an input data sequence;
receive a first indication of a first constraint for processing a first portion of the input data sequence, wherein the first indication indicates a relationship between the first constraint and a neural network (NN) for processing the first portion of the input data sequence;
process the first portion of the input data sequence at a first time utilizing the NN based on the first indication of the first constraint;
while being configured for continued receipt of the input data sequence, receive a second indication of a second constraint for processing a second portion of the input data sequence, wherein the second indication indicates a relationship between the second constraint and the NN for processing the second portion of the input data sequence; and
adapt, based on the second indication, the NN to process a second portion of the input data sequence, wherein the processor is configured to adapt the NN according to one or more parameters of a function based on the second indication to process the second portion of the input data sequence; and
process the second portion of the input data sequence at a second time utilizing the adapted NN based on the second indication.

41. The WTRU of claim 40, wherein the adaptation of the NN is configured to cause the NN to skip more of the second portion of the input data sequence than the first portion of the input data sequence that is configured to be processed by the NN based on the first indication.

42. The WTRU of claim 40, wherein the first constraint comprises at least one of a computational resource availability or a data processing accuracy.

43. The WTRU of claim 42, wherein the NN is configured to have a computational load, wherein the computational load is greater before being adapted than after being adapted, and wherein the first indication indicates a greater computational resource availability than the second indication.

44. The WTRU of claim 43, wherein the NN comprises a skip recurrent NN (RNN) model, wherein the skip RNN model is configured to have a lower computational load when processing the second portion of the input data sequence based on the second indication than when processing the first portion of the input data sequence based on the first indication.

45. The WTRU of claim 42, further comprising a transceiver, and wherein the processor is further configured to:
transmit, via the transceiver to a device other than the WTRU, at least one value indicating a computational cost or an accuracy value associated with the NN when processing the input data sequence, wherein the computational cost value is associated with the computational resource availability, and the accuracy value is associated with the data processing accuracy.

46. The WTRU of claim 43, wherein the processor is configured to adapt the NN to enable processing of the second portion of the input data with a lower computational load, and wherein the NN is configured to minimize a loss in accuracy after the adaptation.

47. The WTRU of claim 42, further comprising a transceiver, and wherein the processor is further configured to:
receive, via the transceiver from a device other than the WTRU, a target computational cost or an accuracy value, wherein the NN is adapted to achieve the target computational cost or the accuracy value, wherein the computational cost value is associated with the computational resource availability, and the accuracy value is associated with the data processing accuracy.

48. The WTRU of claim 43, further comprising a transceiver, and wherein the processor is further configured to:
receive, via the transceiver from a device other than the WTRU, a command to increase or decrease the computational load of the NN by a defined amount; and
adapt, based on the command, the NN to process a third portion of the input data sequence.

49. The WTRU of claim 40, wherein the input data sequence comprises video data or audio data, and wherein the processor is configured to process the video data or the audio data using an encoder or a decoder on the WTRU.
